(19) United States
(12) Patent Application Publication
(10) Pub. No.: US 2002/0086647 A1
(43) Pub. Date: Jul. 4, 2002

(54) Electronic device and means for securing a detachable unit into operating position

(76) Inventor: Mika Ilvonen, Tampere (FI)

Correspondence Address: PERMAN & GREEN, 425 POST ROAD, FAIRFIELD, CT, 06430, US

(21) Appl. No.: 10/033,423

(22) Filed: Dec. 27, 2001

(30) Foreign Application Priority Data
Dec. 29, 2000 (FI) 20002897

(51) Int. Cl. H04B 1/38

(52) U.S. Cl. 455/90; 455/575; 455/572

(57) ABSTRACT

The invention relates to a back cover for an electronic device and a method for retaining and locking a detachable electronic unit in an internal compartment of an electronic device. The invention relates to a electronic device comprising an internal compartment for retaining a detachable unit; a back cover for closing said internal compartment and covering the unit; and electronic contacts for establishing an electrical connection with said unit. Said back cover comprises a guiding means for pushing and holding said unit against said contacts and for securing said electrical connection. Said guiding means and said contacts are dimensioned to press the unit between said guiding means and said contacts with a force adequate for securing said electrical connection while said back cover is closed.

### TECHNICAL FIELD OF THE INVENTION

The invention relates to means for securing an electronic unit, e.g. a battery pack or a memory card, into operating position and enabling easy insertion and detachment of the unit.

Internal batteries in are traditionally used in portable communication units, such as Nokia™ mobile phones 3210 and 8850 or Motorola™ mobile phones cd920 and L7089. The Nokia™ 3210 mobile phone has holding means located mainly on the battery and protruding parts that project into slots in the battery compartment. One of these protruding parts can be depressed to release the battery from the battery compartment.

The Nokia™ 8850, Motorola™ cd920 and L7089 mobile phones all have batteries that are squeezed into the battery compartment and pressed in a holding position in the battery compartment by resilient battery contacts. The battery contacts are depressed, establishing a pressure on the battery when the battery is placed into the battery compartment. The Motorola™ cd920 mobile phone has two slots at one end of the battery and another slot at the other end of the battery, wherein protruding parts from the battery compartment project outwards. The Motorola™ L7089 mobile phone has two protruding parts at each end of the battery, said protruding parts projecting into slots in the battery compartment. The Nokia™ 8850 mobile phone has two slots at one end of the battery, wherein the protruding parts projects from the battery compartment.

Prior art battery locks are arranged to lock the battery pack in place in the battery compartment for avoiding dropping or unintentional releasing of the battery while the back cover is not in position. The battery lock may be arranged to hold the battery in the compartment loosely without pressing the battery against the battery contacts.

Alternatively, pressing may be effected by resilient contacts and/or spring elements between which the battery is held.

### SUMMARY OF THE INVENTION

An object of the present invention is to provide an electronic device as set forth in the preamble of claim 1. According to the claimed invention this objective is obtained by an electronic device characterized in what is presented in the characterizing part of claim 1.

Another object of the present invention is to provide a back cover for an electronic device as set forth in the preamble of claim 8. According to the claimed invention this objective is obtained by a back cover characterized in what is presented in the characterizing part of claim 8.

Yet another objective of the claimed invention is to provide a method for holding and locking a detachable electronic unit as set forth in the preamble of claim 11. According to the claimed invention this objective is obtained by a method characterized in what is presented in the characterizing part of claim 11.

With the invention, considerable advantages are achieved, particularly during manual insertion, and detachment of the battery. The need for tight fastening and accurate positioning by the user is eliminated, wherein the guide means, e.g. a protruding wedge means, is dimensioned to guide and squeeze the unit into the correct place. The wedge means are situated in the separate back cover of the electrical device, e.g. a communication unit, and arranged to press the battery or the memory card in a reliable manner against the electronic contacts of the compartment when closing the cover. Pressing force is not needed upon opening the back cover, wherein the loose detachable unit is easy to remove.

### BRIEF DESCRIPTION OF THE DRAWINGS

In the following, the present invention will be described in more detail with reference to the appended drawings, in which

FIG. 1 shows, in a perspective view, a prior art communication unit, seen from above,

FIG. 2 shows, in a perspective view, the communication unit according to FIG. 1, seen from below,

FIG. 3 schematically shows the essential parts of a telephone for communication with a cellular network,

FIG. 4 shows a communication unit where a removable back cover has been removed, with an internal battery in operative position,

FIG. 5 shows a communication unit where a removable cover has been removed, without an internal battery located in operative position,

FIG. 6 shows a prior art internal battery, in a perspective view seen from above,

FIG. 7 shows, in a perspective view, the internal battery according to FIG. 6, seen from below and,

FIG. 8 shows the internal battery and a section of the removable back cover according to the present invention at the point A-A of FIG. 2 of a corresponding communication unit which is arranged according to the present invention,

FIG. 9 shows an embodiment of the battery pack according to the present invention in a perspective view seen from above,

FIG. 10 shows another embodiment of the battery pack according to the present invention in a perspective view seen from above.

### DETAILED DESCRIPTION OF EMBODIMENTS

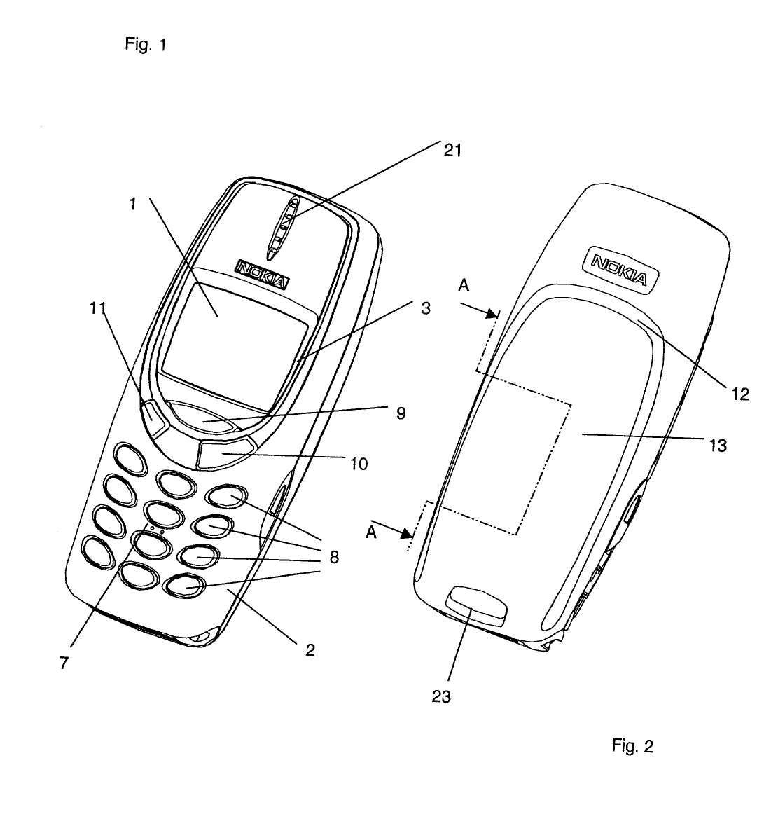

According to a first aspect, the communication unit according to the present invention will be described with reference to an electronic device, especially a hand portable phone, preferably a cellular/mobile phone. A prior art phone is shown in FIGS. 1 and 2, where a cellular/mobile phone is shown in a perspective view. As the figures illustrate, the phone is provided with a front cover 2 having a window frame 3 encircling the protection window of a display assembly 1. The cellular/mobile phone comprises a user interface having an on/off button 4 (shown in FIG. 4), a keypad 7, a battery 14 (shown in FIG. 4), an internal antenna 24 (shown in FIG. 4), a display/LCD 1, an earpiece 21 and a microphone 22 (not shown). In FIG. 2, the phone is shown from another perspective, the wherein back cover 13 can be seen. FIG. 2 also shows a release device 23 for releasing the back cover 13 from the rest of the phone, and a horseshoe-shaped edge 12.

The keypad 7 has a first group of keys 8 as alphanumeric keys, by means of which the user can for example enter a telephone number, write a text message (SMS), and write a name (associated with the phone number). Each of the twelve alphanumeric keys 8 is provided with a figure “0-9” or a sign “#” or “*”, respectively. In alpha mode, each key is associated with a number of letters and special signs used in text editing.

The keypad 7 additionally comprises a menu selection key 9, an up/down key 10, and a cancel key 11. The functionality of the menu selection key or NaviKey™ 9 depends on the state of the phone. The cancel key 11 is used to delete an input, or cancel the last selection and jump to another menu level.

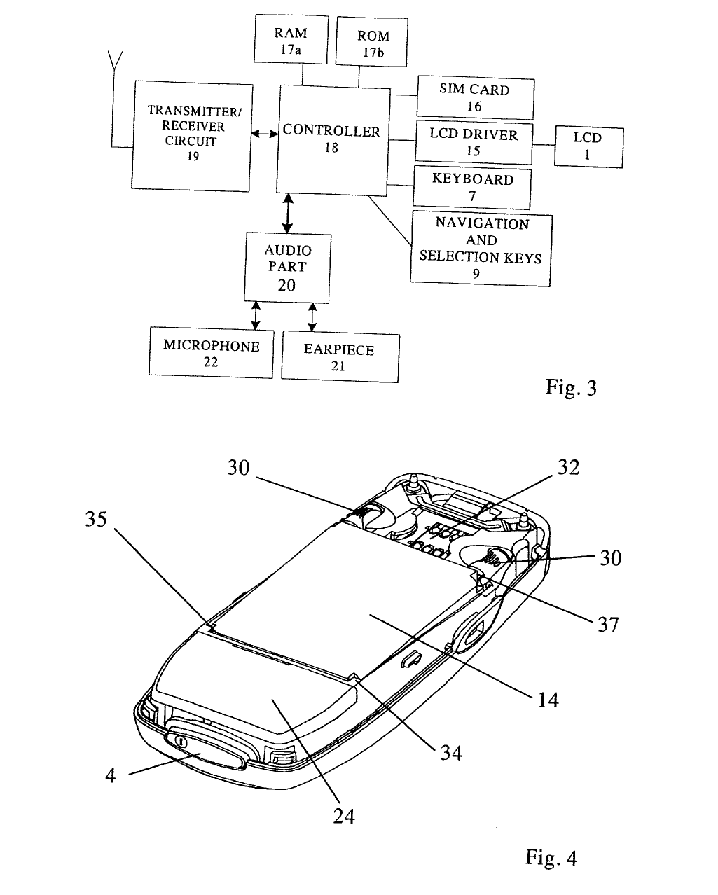

FIG. 3 schematically shows the most important parts of the phone/terminal. The microphone 22 records the user's speech, and the analogue signals formed thereby are A/D converted in an A/D converter (not shown) before the speech is encoded in an audio part 20. The encoded speech signal is transferred to the controller 18 (physical layer processor), which for example supports the GSM terminal software. The controller 18 also forms the interface to the peripheral units of the apparatus, including RAM and ROM memories 17a and 17b, a SIM card 16, the display 1 and the keypad 7 (shown in FIG. 1) as well as data, power supply, etc. The controller 18 communicates with the transmitter/receiver circuit 19. The audio part 20 speech-decodes the signal, which is transferred from the controller 18 to the earpiece 21 via a D/A converter (not shown). The controller 18 is connected to the user interface. Thus, the controller 18 monitors the activity in the phone and controls the display 1 in response thereto.

The phone is adapted for use in connection with the GSM network, but, of course, the invention may also be applied in connection with other telephone networks, such as cellular networks, various cordless telephone systems, or in dual band phones accessing sets of these systems/networks. The invention may also be applied in connection with other electronic devices having internal compartments for detachable electronic units and back covers and using battery packs or extension cards or both. An embodiment of the present invention will be described with reference to the appended FIGS. 4 to 10.

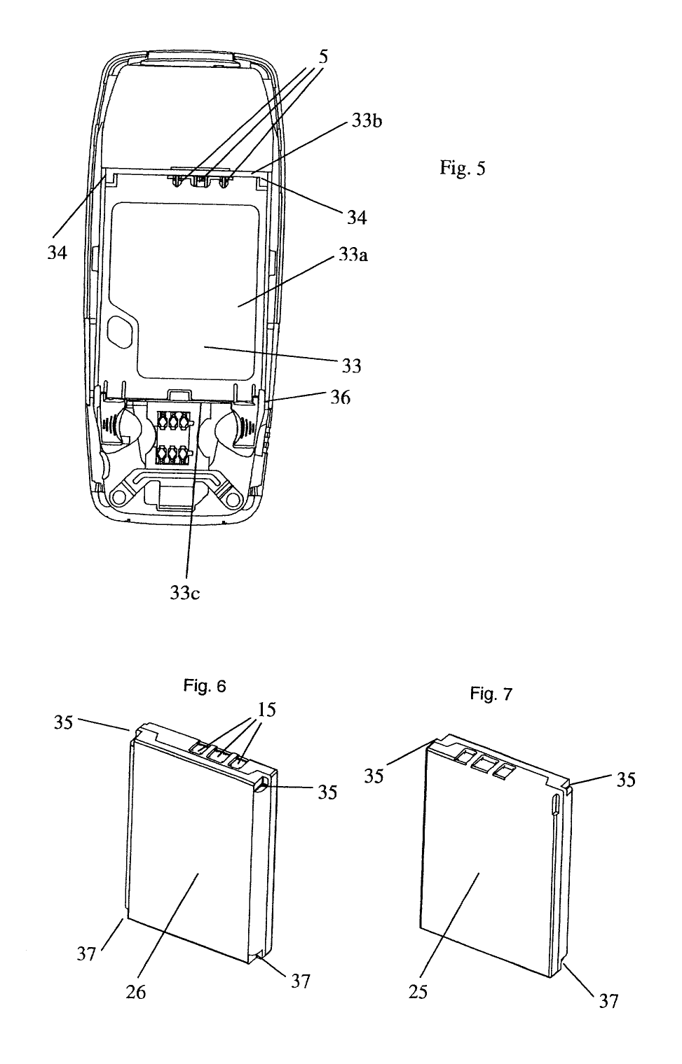

FIG. 4 shows the back side of the communication unit when the removable back cover 13 (shown in FIGS. 1 and 2) is removed and the battery 14 is visible. The figure also shows a SIM card reader 32 that is only accessible when the battery 14 is removed. FIG. 5 shows the back side of the communication unit when the battery 14 removed and the compartment 33 for the battery 14 is visible showing resilient electronic contacts 5 for the battery 14. An internal compartment for an extension card or a memory card is arranged in a similar manner. The battery compartment 33 forms an integral part of the electronic device. The battery compartment 33 is also provided at one end with protrusions 34 projecting into corresponding recesses 35 (shown in FIG. 4) on the battery 14, to hold the battery 14 in the operating position in the battery compartment 33. The protrusions 34 are arranged to prevent the rectangular battery 14 from moving up in a transversal direction in relation to a pressing direction of the battery 14, which pressing is intended to secure a good electrical contact between the battery contacts 5 and the battery 14. The up direction refers here to the direction substantially perpendicular to the bottom 33a of the compartment 33. The battery 14 is provided with metallic contact pads 15 for interaction with the corresponding resilient battery contacts 5. In a preferred embodiment of the invention, the pressing direction and the bottom 33a are parallel with each other. The cover 13 is removed by sliding it to the direction of the button 4 over the antenna 24 (the pressing direction) and then lifting the cover 13 up. Latches and grooves on the sides of the device lock the cover 13 in place. In a preferred embodiment of the communication unit according to the present invention, the cover 13 is opened by sliding it to the opposite direction. Thus, the pressing direction and the sliding movement for closing the cover 13 are directed to the same direction. Latches and grooves for locking the cover 13 are arranged accordingly in a way known as such to a one skilled in the art. The other end of the battery compartment 33 comprises a battery lock 30. The battery lock 30 is provided with taps 36 that project into another set of corresponding recesses 37 on the battery 14 for holding the battery 14 in the operating position in the battery compartment 33. The taps 36 snap into place upon insertion of the battery 14.

FIG. 5 illustrates the back side of the communication unit when the battery 14 is removed from the battery compartment 33 and in FIGS. 6 to 7 the battery pack 14 is shown separately.

The battery 14 is removed from the battery compartment 33 by opening the battery lock 30. By opening, the taps 36 are removed out of the recesses 37 and the battery 14 is released and free to be removed by hand.

In FIGS. 6 and 7, the battery 14 is shown when it is removed from the battery compartment 33. The battery 14 is, as mentioned earlier, provided with recesses, or slots 35, 37 that interact with protrusions, and taps 34, 36 to hold the battery 14 in the battery compartment 33. Said slots and protrusions in combination prevent the battery 14 from detaching from the battery compartment 33 by any other way than by releasing the battery lock 30. The battery 14 is usually flat and rectangular, having typically three contact pads 15 for electrical contact with the corresponding battery contacts 5, which electrical contact is secured with their mutual pressing force. The contact pads 15 are arranged at one end of the battery 14 and on a side wall 28 arranged to be substantially perpendicular in relation to the pressing direction described earlier. The lower side 25 of the battery 14 is placed at the bottom 33a of the battery compartment 33. The contacts 5 are situated on a side wall 33b of the battery compartment 33 to interact with the contacts 5. The protrusions 34 are situated on the same wall 33b and the taps 36 are situated on the opposite wall 33c.

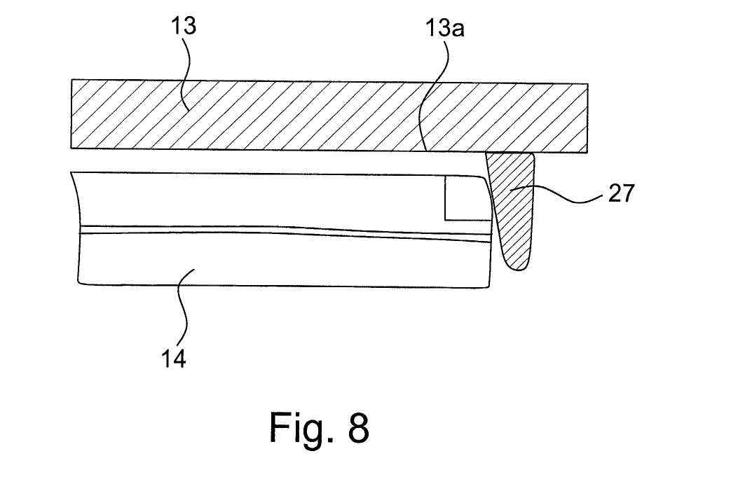

FIG. 8 schematically shows the most important parts of a preferred embodiment of the protruding wedge means, said parts being essential to the understanding of the present invention. The wedge means 27, the back cover 13 and the battery 14 are shown in positions similar to a situation when the battery 14 is held in the battery compartment 33 with the cover 13 in place. The cover 13 and the upper side 26 and the lower side 25 of the battery 14 are substantially parallel with each other.

The protruding wedge means 27 are arranged to extend from the inner side 13a of the cover 13. The inner side 13a faces the battery compartment 33. The protruding wedge means 27 comprise at least one wedge 27 extending in a transversal direction from the inner side 13a into the compartment 33. The angle of the wedge 27 is about 10 degrees from perpendicular on a side intended to be facing the battery 14, separate from the cover 13, and intended to press the battery 14 in the pressing direction towards the contacts 5. The wedge 27 is angled for effecting a clamping feature while closing the cover 13 for squeezing the battery 14 against the contacts 5. The angled wedge 27 presses simultaneously the battery 14 slightly against the bottom 33a. The loose battery 13 is slidingly driven at the bottom 33a towards the contacts 5. The wedge 27 presses the edge of a side wall of the battery 14.

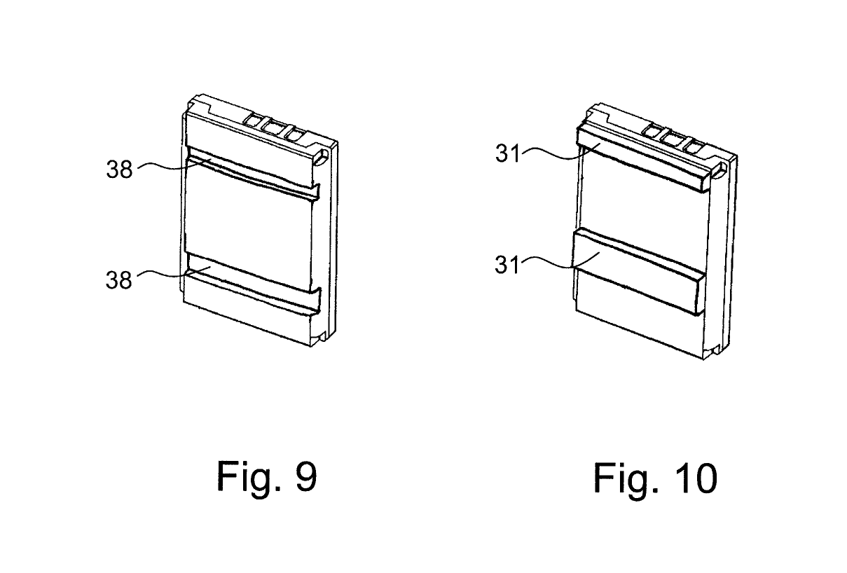

In FIG. 9, on the upper side 26 of the battery 14 may alternatively be arranged one or more notches or recesses 38 into which the wedge 27 intrudes. Advantageously, in the pressing direction, the notch 38 is slightly broader than the wedge 27. The wedge 27 presses a side wall of the recess 38 for effecting the pressing force. Advantageously, the side wall is parallel to the side wall 28. While the cover 13 is removably or permanently hinged, the arched closing movement of the cover 13 drives the battery 14 against the contacts 5 even if the wedge 27 is not angled, i.e. the angle is zero degrees. Instead, a side wall of the battery 14 may be angled. The end of a pin-like wedge touches the angled side wall and guides the battery 14 when the cover 13 is lowered. The end of the cover 13 is hingedly attached to the device and the contacts 5 are situated inside the curvature of the arched movement.

In FIG. 10, in another embodiment of the invention the upper side 26 of the battery 14 is provided with one or more elevated forms 31. A sliding cover is provided with ribs, protrusions or pins which hit a side of the elevated form and press the battery 14 against the contacts 5 while closing the cover. The cover slides over the battery 14 towards the contacts 5.

To align the contacts 5 better with the pads 15 the lateral movevent of the battery 14 may be restricted, for example, by ribs or protruding parts on both sides or on one side of the compartment 33. The ribs and the protruding parts press against the side walls of the battery 14. The ribs or the protruding parts may be arranged to hold the battery in place when the cover 13 is not in place. Thus, the protrusions and taps 34, 36 may be replaced by the ribs or the protruding parts. The pressing force of the ribs is arranged to keep the battery in place in different postures of the device. The ribs or the protruding parts may also be arranged for avoiding dropping the battery wherein the battery 14 is pressed pass the ribs into the compartment 33. A tight fitting keeps the battery 14 in place.

The wedge 27 and the battery contacts 5 are dimensioned to press the battery 14 between said wedge 27 and battery contacts 5 with a force adequate for securing the electrical connection during the use of the device. In the presented embodiment, the wedge 27 interacts with the side of the battery 14 opposite to the pads 15 (a side wall 29). The width of the wedge 27 may be varied, and two or more wedges can be arranged in a similar alignment in relation to the battery 14. The height of the wedge 27 is dimensioned to fit into the compartment 33 or, more preferably, into a recess formed in a side wall 29 of the compartment 33. The cover 13, a removable or a hinged cover, attached to the device may move pivotally in relation to the battery 14, slidingly towards the contacts 5, and/or in a lowering fashion onto the compartment 33, while locking into place. In different embodiments of the cover, the wedge 27 is always positioned and dimensioned to be moved with the cover 13 at some stage to a location at the battery 14 for effecting described securing feature. The wedge means 27 form an integral part of the back cover 13 and, being of plastic material, provide resilient clamping feature.

Electronic devices are often provided with extension card interfaces or card slots for adding a memory storage to the device. Standards define the specifications of these memory cards, such as MultiMediaCard (size 32 mm×24 mm×1,4 mm), Miniature Card (size 38 m×33 mm ×3,5 mm), SmartMedia Card™ (size 45 mm×37 mm×0,76 mm) and CompactFlash™ card (sixe 42,8 mm×36,4×3,3 mm). The memory cards are provided with pin connectors for electrical coupling and they may have contact pads similar to the pads 15 of the battery 14. The cards are pressed and held against a corresponding connector (the male or the female part of the connector) for securing electrical connection. The movement of the card and the pressing direction are similar to the battery described earlier.

The lateral movement of the card should often be restricted for aligning the connectors and the pins more precisely. The cover 13 may be provided with other wedges, pins (the cover moving pivotally), bevelled forms (the cover moving slidingly) or other members of the guide means on the underside of the cover 13 for the tranversal alignment of the battery or the card. While closing the cover 13, the loose electronic unit is guided between two opposite members or between a member and a side wall of the compartment. Said side wall is situated adjacent to the contacts 5. The method is especially applicable to a unit with contact pads (e.g. the pads 15) which allow tranversal movement while in contact with the contacts of the device (e.g. the contacts 5).

The invention is not limited to the above-described examples or to the drawings showing examples of one embodiment, but can be varied within the scope of the appended claims.

1. An electronic device comprising an internal compartment for retaining a detachable electronic unit; a back cover for closing said internal compartment and covering the unit when said unit is installed into said internal compartment; and electronic contacts, on a side of said internal compartment, for establishing an electrical connection with said unit when said unit is placed into said compartment, characterised in that said back cover comprises a guiding means for pushing said unit against said electronic contacts while closing said back cover.

2. An electronic device according to claim 1, characterised in that said guiding means is arranged for holding said unit against said electronic contacts while said back cover is closed for securing said electrical connection.

3. An electronic device according to claim 1 or 2, characterised in that said guiding means is arranged to align said unit transversally with said electronic contacts while closing said back cover.

4. An electronic device according to claim 1 or 2, characterised in that said guiding means comprises a protruding wedge means which are arranged to extend from a side of said back cover facing said compartment.

5. An electronic device according to claim 1 or 2, characterised in that said guiding means and said electronic contacts are dimensioned to press the unit between said guiding means and said electronic contacts with a force adequate for securing said electrical connection while said back cover is closed.

6. An electronic device according to claim 1, characterised in that said unit is a battery pack for an electronic device such as a communication unit.

7. An electronic device according to claim 1, characterised in that said unit is an extension card, such as a memory card.

8. A back cover for an electronic device, said device comprising an internal compartment for retaining a detachable electronic unit; and electronic contacts on a side of said internal compartment, for establishing an electrical connection with said unit when said unit is placed into said compartment, said back cover being arranged for closing said internal compartment and covering said unit when said unit is installed into said internal compartment, characterised in that said back cover comprises a guiding means for pushing said unit against said electronic contacts.

9. A back cover according to claim 8, characterised in that said guiding means is arranged for holding said unit against said electronic contacts while said back cover is closed for securing said electrical connection.

10. A back cover according to claim 8 or 9, characterised in that said guiding means comprises a protruding wedge means which are arranged to extend from a side of said back cover facing said compartment.

11. A method for retaining and locking a detachable electronic unit in an internal compartment of an electronic device, said device comprising electronic contacts on a side of said internal compartment for establishing an electrical connection with said unit, when said unit is placed into said internal compartment; and a back cover for closing said internal compartment and covering said unit when said unit is installed into said internal compartment, characterised in that the method comprises the step of pushing said unit towards and against said electronic contacts by using a guiding means arranged on said back cover while closing said back cover.

12. A method according to claim 11, characterised in that the method further comprises the step of holding said unit against said electronic contacts with a force for securing said electrical connection by using said guiding means while said back cover is closed.

13. A method according to claim 11 or 12, characterised in that the method further comprises the step of sliding said loose unit towards said electronic contacts along the bottom of said compartment, and holding resiliently said unit between said guiding means and said electronic contacts while said back cover is closed.

14. A method according to claim 11 or 12, characterised in that the method further comprises the step of aligning said unit transversally with said electronic contacts while closing said back cover.
